(19) United States
(12) Patent Application Publication
(10) Pub. No.: US 2007/0059521 A1
(43) Pub. Date: Mar. 15, 2007

(54) Halogen-free flame-retardant acrylic pressure-sensitive adhesive sheet or tape

(76) Inventor: Sawako Nakamura, Kanagawa (JP)

Correspondence Address: 3M INNOVATIVE PROPERTIES COMPANY, PO BOX 33427, ST. PAUL, MN, 55133-3427, US

(21) Appl. No.: 10/595,089

(22) PCT Filed: Jun. 30, 2004
(86) PCT No.: PCT/US04/21016

§ 371 Date: Feb. 7, 2006

(30) Foreign Application Priority Data
Aug. 8, 2003 (JP) 2003-206774

(51) Int. Cl. B32B 7/12; B32B 27/30; C09J 133/00

(52) U.S. Cl. 428/355 AC; 428/343

(57) ABSTRACT

The object of the present invention is to provide a flame-retardant pressure-sensitive adhesive sheet or tape that has adequate adhesive performance without containing a halogen-based flame retardant. In a first aspect of the present invention, a flame-retardant pressure-sensitive adhesive sheet or tape is provided that comprises an acrylic polymer containing units originating in alkyl(meth)acrylate monomer, nitrogen-containing monomer and carboxyl group-containing monomer, and a metal hydrate compound. In a second aspect of the present invention, a flame-retardant pressure-sensitive adhesive tape or sheet comprises a flame retardant-containing pressure-sensitive adhesive layer containing an acrylic polymer containing units originating in alkyl(meth)acrylate monomer and nitrogen-containing monomer or carboxyl group-containing monomer, and a metal hydrate compound; and, a second pressure-sensitive adhesive layer in contact with at least a portion of at least one side of the flame retardant-containing pressure-sensitive adhesive layer and containing an acrylic polymer containing units originating in alkyl(meth)acrylate monomer and carboxyl group-containing monomer or nitrogen-containing monomer.

### DETAILED DESCRIPTION OF THE INVENTION

The present invention relates to a flame-retardant acrylic pressure-sensitive adhesive sheet or tape.

Many of the materials used in electronic equipment and their components are required to be flame-retardant. Although halogen-based (e.g., bromine) flame retardants, which are considered to offer high performance, are typically used as flame retardants contained in these components, there are problems with respect to the generation of smoke and toxic products during combustion as well as problems in terms of the disposal of compounds containing flame retardants. Consequently, the amounts of halogen-based flame retardants used in materials present in electronic equipment and components are being required to be reduced or such use is being required to be avoided. At present, known examples of halogen-free flame retardants that can be added to pressure-sensitive adhesive sheets or tape as an alternative to halogen-based flame retardants include metal hydrate compounds, phosphate esters, ammonium polyphosphates and red phosphorous (refer to, for example, Japanese Unexamined Patent Publication No. 2002-161258, Japanese Unexamined Patent Publication No. 11-323268, Japanese Unexamined Patent Publication No. 11-269438, and Japanese Unexamined International Patent Publication No. 10-501009 (WO 95/32257).

However, phosphate esters and ammonium polyphosphates have low levels of flame retardation performance in comparison with bromine-based flame retardants. Moreover, since phosphorous-based flame retardants also acts as plasticizers in plastics, extreme softening of the pressure-sensitive adhesive and bleeding of the flame retardant to the surface of the pressure-sensitive adhesive layer occur, thereby causing a decrease in adhesive performance and preventing the maintaining of adequate holding strength. Although red phosphorous is frequently added as an assistant for improving the effect of phosphorous-based flame retardants, it has the problem of generating phosphine gas during combustion.

On the other hand, if a metal hydrate compound is selected as a flame retardant, it is necessary to add a large amount of metal hydrate compound in order to obtain the same degree of flame retardation as a bromine-based flame retardant. Although acrylic pressure-sensitive adhesives are normally composed of a copolymer of alkyl acrylate and a monomer containing a carboxyl group such as acrylic acid, a substantial decrease in adhesive performance is unavoidable when a carboxyl group-containing monomer and metal hydrate compound are both present. More specifically, the addition of metal hydrate compound brings about a decrease in the adhesive performance of the pressure-sensitive adhesive with respect to such factors as adhesive strength, holding strength and initial adhesion. Moreover, the addition of metal hydrate compound causes the pressure-sensitive adhesive to lose flexibility, which decreases the ability of the pressure-sensitive adhesive to match the shape of the adhered object, thereby preventing adequate sealing with the adhered object.

Japanese Unexamined Patent Publication No. 11-269438 discloses a pressure-sensitive adhesive containing 50-250 parts by weight of a metal hydrate compound to 100 parts by weight of a pressure-sensitive adhesive composed of 100 parts by weight of an acrylic copolymer, which is obtained from a monomer mixture requiring 50 parts by weight or more of (meth)acrylate monomer containing an alkyl group having 4-14 carbon atoms and 0.5-10 parts by weight of a copolymerizable polar vinyl monomer, and 10-100 parts by weight of a tackifying resin. In this document, although examples of polar vinyl monomers include carboxyl group-containing monomers such as acrylic acid, itaconic acid, (anhydrous) maleic acid and (anhydrous) fumaric acid, as well as nitrogen-containing monomers such as acrylamide, only acrylic acid is actually used in the examples. Although the decrease in adhesive strength may be able to be compensated for to a certain degree by adding a tackifying resin to a pressure-sensitive adhesive containing a metal hydrate compound together with a typical copolymer of alkyl acrylate monomer and acrylic acid, adequate holding strength cannot be obtained.

### SUMMARY

An object of the present invention is to provide a flame-retardant pressure-sensitive adhesive sheet or tape having adequate adhesive performance without containing a halogen-based flame retardant.

In order to solve the above problems, one aspect of the present invention provides a flame-retardant acrylic pressure-sensitive adhesive sheet or tape comprising: an acrylic polymer containing units derived from an alkyl(meth)acrylate monomer, a nitrogen-containing monomer and a carboxyl group-containing monomer, and a metal hydrate compound.

Since this pressure-sensitive adhesive sheet or tape does not contain a halogen, there is no generation of toxic substances during combustion. In addition, both adhesive strength and holding strength are superior despite containing a metal hydrate compound for the flame retardant.

A different aspect of the present invention provides a flame-retardant acrylic pressure-sensitive adhesive tape or sheet comprising: a flame retardant-containing pressure-sensitive adhesive layer containing an acrylic polymer containing units derived from an alkyl(meth)acrylate monomer and a nitrogen-containing monomer, and a metal hydrate compound; and a second pressure-sensitive adhesive layer in contact with at least a portion of at least one side of the flame retardant-containing pressure-sensitive adhesive layer and containing an acrylic polymer containing units derived from an alkyl(meth)acrylate monomer and a carboxyl group-containing monomer.

This pressure-sensitive adhesive sheet or tape does not cause a decrease in adhesive performance due to interaction between the carboxyl group and metal hydrate compound. In addition, the adhesive surface of the pressure-sensitive adhesive sheet or tape does not have a flame retardant due to the presence of the second pressure-sensitive adhesive layer. Consequently, a decrease in adhesive performance due to flame retardant can be prevented. Moreover, since the unit derived from a nitrogen-containing monomer in the flame retardant-containing pressure-sensitive adhesive layer and the unit derived from a carboxyl group-containing monomer in the second pressure-sensitive adhesive layer have high affinity, there is adequate inter-layer adhesion between these layers without having to provide a primer layer, thereby preventing the occurrence of inter-layer destruction.

Still another aspect of the present invention provides a flame-retardant acrylic pressure-sensitive adhesive sheet or tape comprising: a flame retardant-containing pressure-sensitive adhesive layer containing an acrylic polymer containing units derived from an alkyl(meth)acrylate monomer and a carboxyl group-containing monomer, and a metal hydrate compound, and a second pressure-sensitive adhesive layer in contact with at least portion of at least one side of the flame retardant-containing pressure-sensitive adhesive layer and containing an acrylic polymer containing units derived from an alkyl(meth)acrylate monomer and a nitrogen-containing monomer.

In this pressure-sensitive adhesive sheet or tape, there is no flame retardant on the adhesive surface of the pressure-sensitive adhesive sheet or tape due to the presence of the second pressure-sensitive adhesive layer. Consequently, a decrease in adhesive performance due to flame retardant can be prevented. Moreover, since the unit derived from a carboxyl group-containing monomer in the flame retardant-containing pressure-sensitive adhesive layer and the unit derived from a nitrogen-containing monomer in the second pressure-sensitive adhesive layer have high affinity, there is adequate inter-layer adhesion between these layers without having to provide a primer layer, thereby preventing the occurrence of inter-layer destruction.

Furthermore, in the case the acrylic polymer contains both a unit derived from a carboxyl group-containing monomer and a unit derived from a nitrogen-containing monomer, the acrylic polymer may contain both units based on these monomers within a single polymer molecule, or it may be a mixture of acrylic polymer containing a unit based on a carboxyl group-containing monomer, and acrylic polymer containing a unit based on a nitrogen-containing monomer.

The following provides a detailed explanation of preferred embodiments of the present invention. Furthermore, since there is no substantial difference between a “pressure-sensitive adhesive sheet” and a “pressure-sensitive adhesive tape”, the term “pressure-sensitive adhesive sheet or tape” is simply described as a “pressure-sensitive adhesive sheet”.

Pressure-Sensitive Adhesive Layer

Metal Hydrate Compound

The flame-retardant pressure-sensitive adhesive sheet of the present invention contains as a metal hydrate compound as a flame retardant. Metal hydrate compounds are preferable in terms of being environmentally advantageous since they do not cause the formation of toxic products during combustion in comparison with halogen-based flame retardants. In addition, since metal hydrate compounds do not have action that plasticizes the pressure-sensitive adhesive layer in comparison with other halogen-free flame retardants such as phosphate esters, ammonium polyphosphates and red phosphorous, they are also preferable because they tend not to have a detrimental effect on the holding strength of the pressure-sensitive adhesive layer.

Examples of metal hydrate compounds used in the present invention include magnesium hydroxide and aluminum hydroxide. The amount of metal hydrate compound added to the pressure-sensitive adhesive layer is suitably selected within a range so as to be able to impart the desired flame-retardant characteristics to the pressure-sensitive adhesive sheet, and there are no particular restrictions on the amount added. The amount of metal hydrate compound added is typically 15-400 parts by weight and preferably 30-200 parts by weight to 100 parts by weight of the pressure-sensitive adhesive layer. This is because if the amount of metal hydrate compound added is within this range, it is able to impart a level of flame retardation to the pressure-sensitive adhesive sheet that passes the UL combustion test (UL 94, V-2). If the amount of metal hydrate compound is excessively high, the flexibility of the pressure-sensitive adhesive sheet is impaired, sealing with the adhered object is lost, and adhesive performance may become inadequate.

In addition, since metal hydrate compounds have high thermal conductivity, they impart thermal conductivity to the pressure-sensitive adhesive sheet. Consequently, the pressure-sensitive adhesive sheet of the present invention can also be used as a heat radiating sheet.

Acrylic Polymer

The pressure-sensitive adhesive sheet of the present invention is characterized by the acrylic polymer that composes the pressure-sensitive adhesive layer containing a unit derived from a carboxyl group-containing monomer and a unit derived from a nitrogen-containing monomer. The pressure-sensitive adhesive layer of the pressure-sensitive adhesive sheet of the present invention may be composed of a single layer or two or more layers.

In the case of a single layer, the pressure-sensitive adhesive layer contains an acrylic polymer containing a unit derived from an alkyl(meth)acrylate monomer, a unit derived from a carboxyl group-containing monomer, and a unit derived from a nitrogen-containing monomer. Alternatively, the pressure-sensitive adhesive layer may be a mixture of an acrylic polymer containing a unit derived from an alkyl(meth)acrylate monomer and a unit derived from a carboxyl group-containing monomer, and an acrylic polymer containing a unit derived from an alkyl(meth)acrylate monomer and a unit derived from a nitrogen-containing monomer. Since the unit derived from a carboxyl group-containing monomer and the unit derived from a nitrogen-containing monomer in the acrylic polymer have polarity, they impart cohesion to the pressure-sensitive adhesive layer and have the action of enhancing adhesive strength and holding strength. However, the metal hydrate compound interacts with the carboxyl group and causes a decrease in adhesive performance (adhesive strength, holding strength). In addition, this interaction also has the problem of decreasing the ability of the pressure-sensitive adhesive sheet to match the shape of an adhered object as a result of hardening the pressure-sensitive adhesive layer. Consequently, this problem can be alleviated by using not only a carboxyl group-containing monomer, but also a nitrogen-containing monomer for the raw materials of the acrylic polymer. On the other hand, in comparison with the case of using only a nitrogen-containing monomer, the case of combining the use of both a nitrogen-containing monomer and carboxyl group-containing monomer results in the demonstration of superior adhesion characteristics (adhesive strength, holding strength).

On the other hand, in the case the pressure-sensitive adhesive layer is composed of two or more layers, a layer containing an acrylic polymer containing at least a unit derived from an alkyl(meth)acrylate monomer and a unit derived from a carboxyl group-containing monomer (to be referred to as Polymer (A)), and a layer containing an acrylic polymer containing at least a unit derived from an alkyl(meth)acrylate monomer and a unit derived from a nitrogen-containing monomer (to be referred to as Polymer (B)) are arranged adjacent to each other. When arranged in this manner, since the carboxyl group-containing monomer is typically acidic while the nitrogen-containing monomer is typically basic, the units resulting from these polar monomers having a high affinity for each other, resulting in satisfactory bonding and sealing of adjacent layers. Consequently, in contrast to conventional pressure-sensitive adhesive sheets typically having a multi-layer pressure-sensitive adhesive layer in which a thermoplastic resin or other primer layer is interposed between each layer, in the pressure-sensitive adhesive sheet of the present invention in the case of having multiple pressure-sensitive adhesive layers, the adhesive strength between each layer is adequate even without using primer layers, and interlayer destruction can be prevented at the time of use. Furthermore, Polymer (A) may also contain a unit derived from a nitrogen-containing monomer, which is the same as or different from one in Polymer (B). Similarly, Polymer (B) may also contain a unit derived from a carboxyl group-containing monomer, which is the same as or different from one in Polymer (A).

In one aspect of an application requiring a high level of adhesive performance on one side of the pressure-sensitive adhesive sheet, a pressure-sensitive adhesive sheet can be provided in which a flame retardant-containing pressure-sensitive adhesive layer containing a metal hydrate compound and Polymer (B), and a second pressure-sensitive adhesive layer containing Polymer (A) but not containing a metal hydrate compound, are laminated. In this case, since the carboxyl group and metal hydrate compound do not interact in the second pressure-sensitive adhesive layer, adequately high adhesive performance can be secured on the side of the second pressure-sensitive adhesive layer. In addition, in a different aspect, a pressure-sensitive adhesive sheet can be provided in which a flame retardant-containing pressure-sensitive adhesive layer containing a metal hydrate compound and Polymer (A), and a second pressure-sensitive adhesive layer containing Polymer (B) but not containing a metal hydrate compound, are laminated. In this case, even though adhesive performance may be decreased due to interaction between the carboxyl group and metal hydrate compound in the flame retardant-containing pressure-sensitive adhesive layer, adequately high adhesive performance can be secured on the side of the second pressure-sensitive adhesive layer. In either case, it is desirable to make the thickness of the flame retardant-containing pressure-sensitive adhesive layer as thick as possible in order to enhance the flame retardation of the pressure-sensitive adhesive sheet. In addition, it is desirable to make the thickness of the second pressure-sensitive adhesive layer as thin as possible within a range that is still capable of securing adhesive performance. Further, the second pressure-sensitive adhesive layer can be continuously or discontinuously laminated on the flame retardant-containing pressure-sensitive adhesive layer. In this context, the term “continuously” means that the layer is formed on the entire surface, and the term “discontinuously” means that the layer is formed on a portion of the surface.

In an application requiring a high level of adhesive performance on both sides of a pressure-sensitive adhesive sheet, the following aspects can be considered based on a similar approach as that described above. In one aspect, the present invention is able to provide a pressure-sensitive adhesive sheet composed of three or more layers in which a flame retardant-containing pressure-sensitive adhesive layer containing a metal hydrate compound and Polymer (B) (core layer) is laminated on both sides with a second pressure-sensitive adhesive layer containing Polymer (A) but not containing a metal hydrate compound (sheath layer). In addition, in a different aspect, a pressure-sensitive adhesive sheet can be provided composed of three or more layers in which a flame retardant-containing pressure-sensitive adhesive layer containing a metal hydrate compound and Polymer (A) (core layer) is laminated on at least a portion of both sides with a second pressure-sensitive adhesive layer containing Polymer (B) but not containing a metal hydrate compound (sheath layer). Each of layers can be continuous or discontinuous.

The flame retardant-containing pressure-sensitive adhesive layer of the pressure-sensitive adhesive sheet of the present invention may also be in the form of foam. In this case, although the coefficient of thermal conductivity of the pressure-sensitive adhesive sheet decreases, the ability of the sheet to match the shape of the adhered object is improved resulting in a higher degree of sealing. Thus, this is particularly advantageous in the case of surface irregularities in the adhered object.

The thickness of the pressure-sensitive adhesive layer in the pressure-sensitive adhesive sheet of the present invention should be suitably selected, and although there are no particular restrictions on this thickness, typically in the case of a single layer consisting only of a flame retardant-containing pressure-sensitive adhesive layer, it is normally 0.1-5 mm, and in the case of multiple layers such as two layers or three layers or more, the thickness of the flame retardant-containing pressure-sensitive adhesive layer is normally 0.1-5 mm, while the thickness of the second pressure-sensitive adhesive layer not containing flame retardant is normally 10-100 μm. This is because if the thickness is as indicated here, the adhesive performance of the pressure-sensitive adhesive sheet is secured, and there is no significant detrimental effect on the flame retardation of the pressure-sensitive adhesive sheet.

Monomers

Monomers used for the acrylic polymer used in the pressure-sensitive adhesive layer are the previously mentioned alkyl(meth)acrylate, carboxyl group-containing monomer and nitrogen-containing monomer. Examples of alkyl(meth)acrylate monomers that can be used in the present invention include (meth)acrylate esters in which the number of carbon atoms of the alkyl group is 22 or less such as ethyl(meth)acrylate, propyl(meth)acrylate, butyl(meth)acrylate, pentyl(meth)acrylate, hexyl(meth)acrylate, 2-ethylhexyl(meth)acrylate, octyl(meth)acrylate, isooctyl(meth)acrylate, nonyl(meth)acrylate, isononyl(meth)acrylate, decyl(meth)acrylate, lauryl(meth)acrylate, palmityl(meth)acrylate, stearyl(meth)acrylate and behenyl(meth)acrylate. The above-mentioned (meth)acrylate is used alone or as a combination of two or more types. Furthermore, although there are no particular restrictions on the alkyl(meth)acrylate, it is typically contained in an amount of 40% or more, preferably 60% or more based on the weight of the entire monomer mixture. However, it is less than 99%.

The carboxyl group-containing monomer is that which is able to copolymerize with the alkyl(meth)acrylate, examples of which include acrylic acid, methacrylic acid, itaconic acid, maleic acid, maleic anhydride, fumaric acid and fumaric anhydride. The carboxyl group-containing monomer is used alone or as a combination of two or more types. Although not intended to restrict the carboxyl group-containing monomer, it is typically contained in an amount of 20% by weight or less based on the weight of the entire monomer mixture. It is contained in an amount of 0.5% by weight or more. If the carboxyl group-containing monomer is present in an excessive amount, satisfactory adhesive performance is unable to be obtained because it is unable to impart adequate initial adhesion to the pressure-sensitive adhesive or because the pressure-sensitive adhesive becomes hard.

The nitrogen-containing monomer is that which is able to copolymerize with the alkyl(meth)acrylate, examples of which include acrylamides (such as dimethylacrylamide, diethylacrylamide and diethylaminoethylmethacrylate), N-vinylpyrolidone, N-vinylcaprolactam and acryloylmorpholine. The nitrogen-containing monomer is either used alone or as a combination of two or types. Although not intended to restrict the nitrogen-containing monomer, it is typically contained in an amount of 50% by weight or less based on the weight of the entire monomer mixture. It is contained in an amount of 0.5% by weight or more. If the nitrogen-containing monomer is present in an excessive amount, satisfactory adhesive performance is unable to be obtained because it is unable to impart adequate initial adhesion to the pressure-sensitive adhesive or because the pressure-sensitive adhesive becomes hard.

Production of Acrylic Polymer

Polymerization of the above monomers can be carried out by a means such as photopolymerization or thermal polymerization using various types of polymerization methods such as solution polymerization, block polymerization, suspension polymerization or emulsification polymerization. Radiation polymerization by gamma ray or electron beam may be used. Photopolymerization is carried out by irradiating a monomer mixture with UV light in the presence of a photopolymerization initiator. Thermal polymerization is carried out by heating a monomer mixture to 50-200° C. in the presence of a thermal polymerization initiator. Although photopolymerization is preferable since it can be carried out comparatively easily, the use of thermal polymerization may also be considered in the case of containing additives such as metal hydrate compounds or optional components in the form of a heat-conducting filler and so forth to be described later, causing the transmittance of UV light through the polymerization materials to be low.

The acrylic polymer may be crosslinked as necessary with a multifunctional acrylate crosslinking agent such as 1,6-hexanediol diacrylate or an isocyanate-based crosslinking agent. Crosslinking with a multifunctional acrylate crosslinking agent can be carried out by adding a multifunctional acrylate to the monomer mixture followed by polymerization. Crosslinking with an isocyanate-based crosslinking agent can be carried out by forming an acrylate polymer using a monomer mixture containing a monomer that contains a group capable of reacting with isocyanate such as a hydroxyl group-containing monomer, and then allowing the isocyanate and group capable of reacting with isocyanate to react. The amount of crosslinking agent is normally 0.01-10 parts by weight to 100 parts by weight of the monomer mixture.

Examples of photopolymerization initiators include benzoin ethers such as benzoin ethyl ether and benzoin isopropyl ether, anisoin ethyl ether and anisoin isopropyl ether, Michler's ketone (4,4′-tetramethyldiaminobenzophenone), 2,2-dimethoxy-2-phenylacetophenone (such as KB-1 from Sartomer or Irgacure™ 651 from Ciba-Specialty Chemical), and substituted acetophenones such as 2,2-diethoxyacetophenone. Other examples include substituted α-ketals such as 2-methyl-2-hydroxypropiophenone, aromatic sulfonyl chlorides such as 2-naphthalenesulfonyl chloride, and optically active oxime compounds such as 1-phenone-1,1-propandione-2-(o-ethoxycarbonyl)oxime. Although there are no particular restrictions on the amount of photopolymerization initiator, it is normally 0.001-5 parts by weight to 100 parts by weight of the monomer mixture.

Examples of thermal polymerization initiators that can be used include organic peroxide free radical initiators such as diacyl peroxides, peroxyketals, ketone peroxides, hydroperoxides, dialkyl peroxides, peroxyesters and peroxycarbonates. Specific examples include lauroyl peroxide, benzoyl peroxide, cyclohexanone peroxide, 1,1-bis(t-butylperoxy)-3,3,5-trimethylcyclohexane and t-butyl hydroperoxide. Alternatively, persulfates and/or bisulfates may also be combined. Although there are no particular restrictions on the amount of thermal polymerization initiator, it is normally 0.001-5 parts by weight to 100 parts by weight of the monomer mixture.

Production of Pressure-Sensitive Adhesive Sheet

The mixture of the above-mentioned monomers, a polymerization initiator and a cross linking agent in the total amount of 100 parts by weight may be used in the production of the pressure-sensitive adhesive sheet. The pressure-sensitive adhesive sheet of the present invention can be produced, for example, in the manner described below. First, the previously mentioned monomers are blended and then polymerized with a suitable means such as UV light in the presence of a polymerization initiator to form a partial polymer (syrup) having a suitable viscosity. Flame retardant in the form of a metal hydrate compound is then added to this syrup to obtain a polymerizing mixture. Other additives such as heat-conducting filler (e.g., alumina, boron nitride), pigment, aging preventive or heat stabilizer may also be added to the polymerizing mixture along with the metal hydrate compound. Next, the resulting polymerizing mixture is coated onto a base material such as polyethylene terephthalate (PET) film subjected to releasing treatment, and in order to block out oxygen that acts as an inhibitory factor during polymerization, another PET film or other film is further layered onto the coated mixture. Next, when the resulting coated mixture is further polymerized with a suitable means such as UV light, a pressure-sensitive adhesive sheet can be obtained provided with a single pressure-sensitive adhesive layer. Multi-layer pressure-sensitive adhesive sheets can be obtained by layering multiple pressure-sensitive adhesive layers produced in the manner described above. Alternatively, in the case the pressure-sensitive adhesive sheet of the present invention is a laminate of a comparatively thick flame retardant-containing pressure-sensitive adhesive layer and a comparatively thin second pressure-sensitive adhesive layer not containing a metal hydrate compound, a multi-layer pressure-sensitive adhesive sheet having adequate sealing can also be obtained by laminating a pressure-sensitive adhesive in the shape of a sheet corresponding to the second pressure-sensitive adhesive layer onto the surface of the flame retardant-containing pressure-sensitive adhesive layer (by, for example, laminating with that in the form of transfer tape). In addition, a multi-layer pressure-sensitive adhesive sheet can also be obtained by coating a monomer mixture or syrup thickened with a partial polymer of a monomer mixture onto a flame retardant-containing pressure-sensitive adhesive layer and then polymerizing according to the procedure described above. Furthermore, in order to obtain a flame retardant-containing pressure-sensitive adhesive layer in the form of foam, a foaming agent such as an azo-based compound can be added to the monomer mixture followed by chemical foaming. In addition, a foam can also be produced by physical foaming using a low boiling point alkane or fluorine-based gas. Alternatively, an another example of a foaming method, a frothing method may be used in which, after partially polymerizing the monomer mixture to increase the viscosity, the mixture is frothed with a frothing machine while supplying nitrogen gas.

The following indicates particularly preferable blends for the pressure-sensitive adhesive layer in the pressure-sensitive adhesive sheet of the present invention.

1. Pressure-Sensitive Adhesive Sheet Composed of a Single Layer

1.1 Flame Retardant-Containing Pressure-Sensitive Adhesive Layer

This layer contains 100 parts by weight of a polymer of a monomer blend containing both nitrogen-containing monomer and carboxyl group-containing monomer, about 30-200 parts by weight of a metal hydrate compound, and as necessary, pigment, aging preventive, heat stabilizer, heat-conducting filler and so forth. Here, the blending ratio of the monomer blend is, for example, as indicated below.

| Nitrogen-containing monomer (such as | Approx. 3-50 | parts by weight |
|---|---|---|
| dimethylacrylamide, diethylacrylamide, | | |
| or diethylaminoethylmethacrylate) | | |
| Carboxyl group-containing monomer | Approx. 1-10 | parts by weight |
| (such as acrylic acid or | | |
| methacrylic acid) | | |
| Alkyl(meth)acrylate | Approx. 40-97 | parts by weight |
| Total | 100 | parts by weight |

2. Multi-layer Pressure-Sensitive Adhesive Sheet
2.1 Flame Retardant-Containing Pressure-Sensitive Adhesive Layer (Containing at Least a Nitrogen-Containing Monomer)

This layer contains 100 parts by weight of a polymer of a monomer blend containing nitrogen-containing monomer, about 30-200 parts by weight of a metal hydrate compound, and as necessary, pigment, aging preventive, heat stabilizer, heat-conducting filler and so forth. Here, the blending ratio of the monomer blend is, for example, as indicated below.

| Nitrogen-containing monomer (such as | Approx. 3-50 | parts by weight |
|---|---|---|
| dimethylacrylamide, diethylacrylamide, | | |
| or diethylaminoethylmethacrylate) | | |
| Carboxyl group-containing monomer | Approx. 0-10 | parts by weight |
| (such as acrylic acid or | | |
| methacrylic acid) | | |
| Alkyl(meth)acrylate | Approx. 40-97 | parts by weight |
| Total | 100 | parts by weight |

2.2 Flame Retardant-Containing Pressure-Sensitive Adhesive Layer (Containing at Least a Carboxyl Group-Containing Monomer)

This layer contains 100 parts by weight of a polymer of a monomer blend containing carboxyl group-containing monomer, about 30-200 parts by weight of a metal hydrate compound, and as necessary, pigment, aging preventive, heat stabilizer, heat-conducting filler and so forth. Here, the blending ratio of the monomer blend is, for example, as indicated below.

| Carboxyl group-containing monomer | Approx. 1-20 | parts by weight |
|---|---|---|
| (such as acrylic acid or | | |
| methacrylic acid) | | |
| Nitrogen-containing monomer (such as | Approx. 0-20 | parts by weight |
| dimethylacrylamide, diethylacrylamide, | | |
| or diethylaminoethylmethacrylate) | | |
| Alkyl(meth)acrylate | Approx. 60-99 | parts by weight |
| Total | 100 | parts by weight |

2.3 Second Pressure-Sensitive Adhesive Layer Not Containing Flame Retardant (Containing at Least a Carboxyl Group-Containing Monomer)

A polymer consisting of the following components is mixed, as necessary, with aging preventive, heat stabilizer, pigment and so forth.

| | | |
|---|---|---|
| Carboxyl group-containing | Approx. 1-20 | parts by weight |
| monomer (such as acrylic acid or | | |
| methacrylic acid) | | |
| Nitrogen-containing monomer | Approx. 0-20 | parts by weight |
| (such as dimethylacrylamide, | | |
| diethylacrylamide, or | | |
| diethylaminoethylmethacrylate) | | |
| Alkyl(meth)acrylate | Approx. 60-99 | parts by weight |
| Total | 100 | parts by Weight |
| Thickness | Approx. 10-100 | micrometers |

2.3 Second Pressure-Sensitive Adhesive Layer not Containing Flame Retardant (Containing at Least a Nitrogen-Containing Monomer)

A polymer consisting of the following components is mixed, as necessary, with aging preventive, heat stabilizer, pigment and so forth.

| | | |
|---|---|---|
| Nitrogen-containing | Approx. 3-50 | parts by weight |
| monomer (such as | | |
| dimethylacrylamide, | | |
| diethylacrylamide, or | | |
| diethylaminoethylmethacrylate) | | |
| Carboxyl group-containing | Approx. 0-10 | parts by weight |
| monomer (such as acrylic acid or | | |
| methacrylic acid) | | |
| Alkyl(meth)acrylate | Approx. 40-97 | parts by weight |
| Total | 100 | parts by Weight |
| Thickness | Approx. 10-100 | micrometers |

A pressure-sensitive adhesive sheet produced in accordance with the present invention using the pressure-sensitive adhesive layers blended in the manner described above were determined to have the following characteristics.
(1) High adhesiveness, and more specifically, adhesive performance when peeled at 180° of 8 N/cm or more.
(2) Satisfactory flame retardation, and more specifically, flame retardation in compliance with the UL flame retardation standard, UV94 V-2.
(3) Satisfactory shape matching to an adhered object, and more specifically, hardness of 60° or less as determined with Asker Model C Rubber Hardness Tester.
(4) High coefficient of thermal conductivity, and more specifically, coefficient of thermal conductivity of 0.3 (W/m·K) or more.
   Form of Pressure-Sensitive Adhesive Sheet

The pressure-sensitive sheet of the present invention may be in the form of a pressure-sensitive adhesive sheet with base material having a single layer or multiple layers of the pressure-sensitive adhesive layer of the present invention on at least a portion of one side or both sides of a base material, or may be in the form of a pressure-sensitive adhesive sheet composed only of a single layer or multiple layers of the pressure-sensitive adhesive layer of the present invention. For example, a pressure-sensitive adhesive sheet having high strength can be formed by providing a pressure-sensitive adhesive layer on the surface of a base material by using for the base material a material such as high-strength polyethylene terephthalate or polyimide. On the other hand, since the pressure-sensitive adhesive sheet of the present invention exhibits superior adhesive performance while also having high thermal conductivity, it can also be used as heat-conducting sheet for coupling electronic components or other exothermic members with heat radiating sheets or other heat radiating members. In such cases, the use of a pressure-sensitive adhesive sheet that does not have a base material makes it possible to fully enjoy the benefits of the high level of thermal conductivity.

Furthermore, the surface of the pressure-sensitive adhesive layer of the pressure-sensitive adhesive sheet may be covered with a removable liner for protection during storage and transport following production.

### EXAMPLES

### Example 1

A mixture obtained by mixing a monomer blend having the following blending ratio in a glass container was partially polymerized by irradiating with ultraviolet light for several minutes using a low-pressure mercury lamp after replacing the dissolved oxygen in the mixed solution with a nitrogen atmosphere.

| | | |
|---|---|---|
| Monomer blend | 100 | parts by weight |

Monomer blending ratio

| | | |
|---|---|---|
| Dimethylacrylamide | 15 | parts by weight (Kohjin) |
| Isooctylacrylate | 83 | parts by weight (3M) |
| Acrylic acid | 2 | parts by weight (Mitsubishi Chemical) |

Polymerization initiator

| | | |
|---|---|---|
| Irgacure 651 | 0.20 | parts by weight (Ciba-Specialty Chemical) |

Flame retardant in the form of a metal hydrate compound (aluminum hydroxide B53, 130 parts by weight, Nikkei Sangyo) was added to 100 parts by weight of the viscous liquid obtained by partial polymerization as described above, and stirred until uniform with a mixer. After knife-coating the resulting liquid mixture onto a polyester film (thickness: 50 micrometers) subjected to releasing treatment to a thickness of 1 mm, the polyester film was covered with a coating liquid for the purpose of blocking out oxygen that acts as an inhibitory factor during photopolymerization. Subsequently, the polyester film was irradiated with ultraviolet light from a low-pressure mercury lamp overhead for about 10 minutes to photopolymerize the monomer in the liquid mixture and obtain a halogen-free, flame retardant pressure-sensitive adhesive sheet.

### Example 2

A halogen-free, flame retardant pressure-sensitive adhesive sheet was obtained by coating a pressure-sensitive adhesive containing a carboxyl group on both sides of the sheet obtained in Example 1 to a thickness of 25 micrometers.

The carboxyl group-containing pressure-sensitive adhesive sheet was a copolymer of the following materials.

Pressure-sensitive adhesive blending ratio:

| | |
|---|---|
| Acrylic acid | 10 parts by weight (Mitsubishi Chemical) |
| Isooctylacrylate | 90 parts by weight (3M) |

### Comparative Example 1

A halogen-free, flame retardant pressure-sensitive adhesive sheet was obtained in the same manner as Example 1 with the exception of making the blending ratio of the photopolymerizing monomer blend as follows and using 110 parts by weight of aluminum hydroxide B73 110 (Nikkei Sangyo) for the flame retardant.

Monomer blending ratio:

| | |
|---|---|
| Diethylacrylamide | 10 parts by weight (Kohjin) |
| n-butylacrylate | 90 parts by weight (Mitsubishi Chemical) |

### Example 3

A halogen-free, flame retardant pressure-sensitive adhesive sheet was obtained by similarly coating the same pressure-sensitive adhesive as Example 2 on both sides of the sheet obtained in Comparative Example 1.

### Example 4

A halogen-free, flame retardant pressure-sensitive sheet was obtained by coating a pressure-sensitive adhesive containing a unit originating in nitrogen-containing monomer to a thickness of 25 micrometers on both sides of a obtained halogen-free, flame retardant pressure-sensitive adhesive sheet obtained in the same manner as Example 1 with the exception of making the blending ratio of the monomer blend as follows and using 130 parts by weight of magnesium hydroxide Kisma 5J (Kyowa Chemical) for the flame retardant.

Monomer blending ratio:

| | |
|---|---|
| Acrylic acid | 5 parts by weight (Mitsubishi Chemical) |
| n-butylacrylate | 95 parts by weight (Mitsubishi Chemical) |

The pressure-sensitive adhesive containing a unit originating in nitrogen-containing monomer was a copolymer of the following materials.

Pressure-sensitive adhesive blending ratio:

| | |
|---|---|
| Diethylacrylamide | 20 parts by weight (Kohjin) |
| Acrylic acid | 3 parts by weight (Mitsubishi Chemical) |
| Isooctylacrylate | 77 parts by weight (3M) |

### Comparative Example 2

A sample sheet was obtained in the same manner as Example 1 with the exception of making the blending ratio of the monomer blend as follows:

Monomer blending ratio:

| | |
|---|---|
| Acrylic acid | 5 parts by weight (Mitsubishi Chemical) |
| n-butylacrylate | 95 parts by weight (Mitsubishi Chemical) |

### Comparative Example 3

A sample sheet was obtained by coating the pressure-sensitive adhesive containing a carboxyl group described in Example 3 onto both sides of the sheet obtained in Comparative Example 2 to a thickness of 25 micrometers.

### Comparative Example 4

A sample sheet was obtained by hot knife coating a polyester-based thermoplastic resin onto both sides of the sheet obtained in Comparative Example 2 to a thickness of 5 micrometers at 100° C., coating the pressure-sensitive adhesive containing a carboxyl group described in Comparative Example 3 thereon to a thickness of 25 micrometers, and covering with a polyester film subjected to releasing treatment followed by press-adhering and heating the surface for 10 seconds at 130° C.

### Comparative Example 5

A mixture of 100 parts by weight of a monomer blend having the blending ratio indicated below in a glass container was partially polymerized by irradiating with ultraviolet light for several minutes using a low-pressure mercury lamp after replacing the dissolved oxygen in the mixed solution with a nitrogen atmosphere.

Monomer blending ratio:

| | | |
|---|---|---|
| Acrylic acid | 5 | parts by weight (Mitsubishi |
| | | Chemical) |
| Isooctylacrylate | 95 | parts by weight (3M) |
| Photopolymerization Initiator | 0.20 | parts by weight (Ciba-Specialty |
| (Irgacure 651) | | Chemical) |

Flame retardant in the form of phosphate ester was then added as indicated below to 100 parts by weight of the viscous liquid obtained by polymerization, and then uniformly stirred with a mixer.

Flame retardant:

| | |
|---|---|
| Leoface 80 | 20 parts by weight (Ajinomoto-Fine-Techno) |

After knife coating the resulting mixture onto a polyester film (50 micrometers) subjected to releasing treatment to a thickness of 1 mm, the polyester film was covered with a coating liquid for the purpose of blocking out oxygen that acts as an inhibitory factor during photopolymerization. Subsequently, the polyester film was irradiated with ultraviolet light from a low-pressure mercury lamp overhead for about 10 minutes to photopolymerize the monomer in the liquid mixture and obtain a sample sheet.

### Comparative Example 6

A sample sheet was obtained in the same manner as Comparative Example 5 with the exception of adding the following flame retardant.

Flame retardant:

| | |
|---|---|
| Aluminum hydroxide B53 | 100 parts by weight (Nikkei Sangyo) |

Evaluation Methods and Evaluation Results of Resulting Pressure-Sensitive Sheet Samples
Evaluation Methods:
1) Adhesive Strength

For determination of adhesive strength of the resulting sheets, a universal tensile testing machine (Autograph (™) manufactured by Shimadzu Corporation) was used and the testing method was the 180 deg. peeling strength based on JIS-Z-0237. Each of samples was obtained from each resulting sheets cut in 25 mm wide and 200 mm long. In the condition of 23+/−2° C. and 65+/−5% RH, each of samples was attached to a stainless steel (SUS304) plate. Samples were compressed with a rubber roller with 2 kg load (rubber hardness: 75 to 85 deg.). The stainless steel plate was washed using toluene solvent and dried completely prior to use. Samples were treated under conditions 23+/−2C and 65+/−% RH and were secured to the tensile testing machine and samples were peeled at a speed of 300 mm/min 180 deg. to the stainless steel plate. The strength when peeled was regarded as adhesive strength and given by the mean value. Adhesive strengths for each resulting sheets were the value measured 20 minutes after compression.

The flame retardation of the resulting sheets was evaluated based on UL standard 94V-2.

2) Flame Retardation

Each of the resulting sheets was cut into 12.7 mm×127 mm (½ inches×5 inches) to form each of five specimens. The specimens were held vertically at one end of the specimens. A burner flame was first applied to the free end of the specimens for 10 second. After this, the application of flame was stopped and then again the flame was applied to the specimens for 10 second.

Each of the resulting sheets was evaluated in accordance with the following examination criteria of UL 94V-2.
The total flaming combustion time (the total time of which the combustion is sustained for after the first application of flame plus which the combustion is sustained for after the second application of flame) is less than 30 seconds.
The sum of the flaming combustion times for each of five specimens is less than 250 seconds.
Flaming and glowing combustion times for each of specimens after the second application of flame are not more than 60 seconds.
The combusting drip is dropped from any one of specimens to ignite cotton disposed below.
Neither one of specimens burns up to their clamp portions.
   3) Sheet Hardness

After laminating the resulting sheets to a thickness of 10 mm, the value (maximum value) obtained immediately after pressing a hardness tester against the sheets was measured as hardness using the Asker Rubber Hardness Tester Type C (Kobunshi Keiki).

4) Sheet Thermal Conductivity

The coefficient of thermal conductivity of the resulting sheets was measured using the High-Speed Thermal Conductivity Tester Model QTM-D3 (Kyoto Electronics Mfg.).

5) Heat-Resistant Shear Holding Strength

The resulting sheets were cut to a size of 25 mm×25 mm (bonded area), and both sides of the pressure-sensitive adhesive surfaces were respectively affixed to stainless steel plates by applying pressure by moving back and forth over the sheets with a 2 kg roller. After allowing to stand for 30 minutes at room temperature (25° C.), a 1 kg weight was suspended in a 90° C. atmosphere, and the amount of time until the sample dropped from the stainless steel plate was measured. As a result of the experiment, those samples that did not drop after 5000 minutes or more were indicated as “5000+”.

The evaluation results are shown in Table 1.

TABLE 1

| | | Ex. 2 | | Ex. 3 | | Ex. 4 | | | |
|---|---|---|---|---|---|---|---|---|---|
| | Ex. 1 | Outer | Inner | Outer | Inner | Outer | Inner | Comp. Ex. 1 | Comp. Ex. 2 |
| | Single layer | layer | layer | layer | layer | layer | layer | Single layer | Single layer |
| Monomers*¹ | A + B | A | A + B | A | B | A + B | A | B | A |
| Isooctylacrylate | 83 | 90 | 83 | 90 | | 77 | | | |
| n-butylacrylate | | | | | 90 | | 95 | 90 | 95 |
| Dimethylacrylamide | 15 | | 15 | | | | | | |
| Diethylacrylamide | | | | | 10 | 20 | | 10 | |
| Acrylic acid | 2 | 10 | 2 | 10 | | 3 | 5 | | 5 |
| Irgacure 651 | 0.2 | — | 0.2 | — | 0.2 | — | 0.2 | 0.2 | 0.2 |
| Flame retardants | Metal | None | Metal | None | Metal | None | Metal | Metal | Metal |
| | hydrate | | hydrate | | hydrate | | hydrate | hydrate | hydrate |
| Aluminum hydroxide | 130 | | 130 | | 110 | | 130 | 110 | 130 |
| Magnesium hydroxide | | | | | | | | | |
| Phosphate ester | | | | | | | | | |

| | | | | | | |
|---|---|---|---|---|---|---|
| Primer layer | — | None | None | None | — | — |
| (Inter-layer thermo-plastic resin) | | | | | | |
| 180° peeling strength (N/cm) | 10 | 21 | 20 | 16 | 8 | 6 |
| Flame retardation (UL 94V-2) | Pass | Pass | Pass | Pass | Pass | Pass |
| Hardness (°) | 43 | 44 | 38 | 48 | 40 | 35 |
| Coefficient of thermal | 0.5 | 0.5 | 0.5 | 0.5 | 0.5 | 0.5 |
| conductivity (W/mk) | | | | | | |
| Heat-resistant shear holding | 312 | 5000+ | 5000+ | 5000+ | 280 | 130 |
| strength (minutes) | | | | | | |

| | Comp. Ex. 3 | | Comp. Ex. 4 | | | |
|---|---|---|---|---|---|---|
| | Outer | | Outer | | Comp. Ex. 5 | Comp. Ex. 6 |
| | layer | Inner layer | layer | Inner layer | Single layer | Single layer |
| Monomers*¹ | A | A | A | A | A | A |
| Isooctylacrylate | 90 | | 90 | | 95 | 95 |
| n-butylacrylate | | 95 | | 95 | | |
| Dimethylacrylamide | | | | | | |
| Diethylacrylamide | | | | | | |
| Acrylic acid | 10 | 5 | 10 | 5 | 5 | 5 |
| Irgacure 651 | — | 0.2 | — | 0.2 | 0.2 | 0.2 |
| Flame retardants | None | Metal hydrate | None | Metal hydrate | P | P + metal Hydrate |
| Aluminum hydroxide | | 130 | | 130 | | 100 |
| Magnesium hydroxide | | | | | | |
| Phosphate ester | | | | | 20 | 20 |

| | | | | |
|---|---|---|---|---|
| Primer layer | None | Present | — | — |
| (Inter-layer thermo-plastic resin) | | | | |
| 180° peeling strength (N/cm) | 5.2*² | 4.8*² | 15 | 10 |
| Flame retardation (UL 94V-2) | Fail | Fail | Fail | Pass |
| Hardness (°) | 35 | 36 | 10 | 13 |
| Coefficient of thermal conductivity (W/mk) | 0.5 | 0.5 | 0.4 | 0.4 |
| Heat-resistant shear holding strength | 15*³ | 6*³ | 2 | 23 |
| (minutes) | | | | |

*¹A indicates a carboxyl group-containing monomer and B indicates a nitrogen-containing monomer.
*²The mode of destruction was inter-layer destruction.
*³The mode of destruction was inter-layer destruction.

The following were determined from the evaluation results.

Examples 1 through 4 were determined to have high degrees of adhesive performance and flame retardation performance, satisfactory matching of the shape of the adhered object and a high coefficient of thermal conductivity.

Comparative Examples 1 and 2 were inferior to the pressure-sensitive adhesive sheet of the present invention with respect to peeling strength and heat-resistant holding strength. These were determined to not be suitable for applications requiring a high degree of adhesive performance.

Inter-layer destruction occurred in Comparative Examples 3 and 4 in the peeling strength and heat-resistant holding strength experiments. Consequently, these were determined to not be suitable for applications requiring a high degree of adhesive performance or applications in which residual adhesive after separation is not preferred. In addition, since these comparative examples did not satisfy the requirements of UL standard 94V-2, they are also not suitable for applications requiring flame retardation.

Comparative Example 5 exhibited a prominent decrease in hardness due to the action of the phosphate ester flame retardant as a plasticizer, and the handling ease during application as well as the heat-resistant holding strength during use also decreased. In addition, since this comparative example also did not satisfy the requirements of UL standard 94V-2 due to the ineffectiveness of the flame retardant, it is not suitable for applications requiring flame retardation.

Comparative Example 6 exhibited decreases in hardness and heat-resistant holding strength similar to Comparative Example 4, and is also not suitable for applications requiring a high degree of adhesive performance.

The halogen-free, flame-retardant pressure-sensitive adhesive sheet of the present invention is able to simultaneously possess high adhesiveness, flame retardation that satisfies the requirements of UL flame retardation standard 94V-2, satisfactory shape matching with respect to an adhered object and high coefficient of thermal conductivity.

1-10. (canceled)

11. A flame-retardant acrylic pressure-sensitive adhesive sheet or tape comprising: an acrylic polymer containing units derived from an alkyl(meth)acrylate monomer, a nitrogen-containing monomer and a carboxyl group-containing monomer, and a metal hydrate compound.

12. A flame-retardant acrylic pressure-sensitive adhesive tape or sheet comprising:
a flame retardant-containing pressure-sensitive adhesive layer containing an acrylic polymer containing units derived from an alkyl(meth)acrylate monomer and a nitrogen-containing monomer, and a metal hydrate compound; and
a second pressure-sensitive adhesive layer in contact with at least a portion of at least one side of the flame retardant-containing pressure-sensitive adhesive layer and containing an acrylic polymer containing units derived from an alkyl(meth)acrylate monomer and a carboxyl group-containing monomer.

13. The flame-retardant acrylic pressure-sensitive adhesive sheet or tape according to claim 12, wherein a unit derived from a carboxyl group-containing monomer is additionally contained as a unit of the acrylic polymer present in the flame retardant-containing pressure-sensitive adhesive layer.

14. The flame-retardant acrylic pressure-sensitive adhesive sheet or tape according to claim 12, wherein a unit derived from a nitrogen-containing monomer is additionally contained as a unit of the acrylic polymer present in the second pressure-sensitive adhesive layer.

15. The flame-retardant acrylic pressure-sensitive adhesive sheet or tape according to claim 12, wherein the second pressure-sensitive adhesive layer is present on at least a portion of both sides of the flame retardant-containing pressure-sensitive adhesive layer.

16. The flame-retardant acrylic pressure-sensitive adhesive sheet or tape according to claim 13, wherein the second pressure-sensitive adhesive layer is present on at least a portion of both sides of the flame retardant-containing pressure-sensitive adhesive layer.

17. The flame-retardant acrylic pressure-sensitive adhesive sheet or tape according to claim 14, wherein the second pressure-sensitive adhesive layer is present on at least a portion of both sides of the flame retardant-containing pressure-sensitive adhesive layer.

18. The flame-retardant acrylic pressure-sensitive adhesive sheet or tape according to claim 15, wherein the second pressure-sensitive adhesive layer is present on at least a portion of both sides of the flame retardant-containing pressure-sensitive adhesive layer, and the flame retardant-containing pressure-sensitive adhesive layer is a foam.

19. A flame-retardant acrylic pressure-sensitive adhesive sheet or tape comprising:
a flame retardant-containing pressure-sensitive adhesive layer containing an acrylic polymer containing units derived from an alkyl(meth)acrylate monomer and a carboxyl group-containing monomer, and a metal hydrate compound, and
a second pressure-sensitive adhesive layer in contact with at least a portion of at least one side of the flame retardant-containing pressure-sensitive adhesive layer and containing an acrylic polymer containing units derived from an alkyl(meth)acrylate monomer and a nitrogen-containing monomer.

20. The flame-retardant acrylic pressure-sensitive adhesive sheet or tape according to claim 19, wherein a unit derived from a nitrogen-containing monomer is additionally contained as a unit of the acrylic polymer present in the flame retardant-containing pressure-sensitive adhesive layer.

21. The flame-retardant acrylic pressure-sensitive adhesive sheet or tape according to claim 19, wherein a unit derived from a carboxyl group-containing monomer is additionally contained as a unit of the acrylic polymer present in the second pressure-sensitive adhesive layer.

22. The flame-retardant acrylic pressure-sensitive adhesive sheet or tape according to claim 19, wherein the second pressure-sensitive adhesive layer is present on at least a portion of both sides of the flame retardant-containing pressure-sensitive adhesive layer.

23. The flame-retardant acrylic pressure-sensitive adhesive sheet or tape according to claim 20, wherein the second pressure-sensitive adhesive layer is present on at least a portion of both sides of the flame retardant-containing pressure-sensitive adhesive layer.

24. The flame-retardant acrylic pressure-sensitive adhesive sheet or tape according to claim 21, wherein the second pressure-sensitive adhesive layer is present on at least a portion of both sides of the flame retardant-containing pressure-sensitive adhesive layer.

25. The flame-retardant acrylic pressure-sensitive adhesive sheet or tape according to claim 22, wherein the second pressure-sensitive adhesive layer is present on at least a portion of both sides of the flame retardant-containing pressure-sensitive adhesive layer, and the flame retardant-containing pressure-sensitive adhesive layer is a foam.
